(19) United States
(12) Patent Application Publication
(10) Pub. No.: US 2023/0378502 A1
(43) Pub. Date: Nov. 23, 2023

(54) APPARATUS FOR CONTROLLING MULTI-MODULE FUEL CELL SYSTEM AND METHOD THEREOF

(71) Applicants: Hyundai Motor Company, Seoul (KR); Kia Corporation, Seoul (KR)

(72) Inventor: Jae Won Jang, Busan (KR)

(21) Appl. No.: 17/969,964

(22) Filed: Oct. 20, 2022

(30) Foreign Application Priority Data
May 20, 2022 (KR) 10-2022-0062109

(51) Int. Cl. H01M 8/04858; H01M 8/04537; H01M 8/04302

(52) U.S. Cl. CPC H01M 8/0494; H01M 8/04619; H01M 8/04302; H01M 8/04873; H01M 2250/20

(57) ABSTRACT

Disclosed are an apparatus and a method for individually controlling fuel cell modules of a multi-module cell system. According to the present disclosure, a driving number calculator calculates a first number, based on a required total output and a preset fuel cell stack reference output in real time, a fuel cell stack driving determiner determines driven ones of the one or more fuel cell stacks, based on priorities of the one or more fuel cells and the first number, and a fuel cell stack output controller controls an output of the driven fuel cell stack based on the required total output. Through the present disclosure, durability degrees of the fuel cell stacks may be secured by controlling voltage for cells of the fuel cell stacks in a proper range.

### CROSS-REFERENCE TO RELATED APPLICATION(S)

This application claims, under 35 U.S.C. § 119(a), the benefit of Korean Patent Application No. 10-2022-0062109, filed in the Korean Intellectual Property Office on May 20, 2022, the disclosure of which is incorporated herein by reference in its entirety.

### BACKGROUND

### Technical Field

Embodiments of the present disclosure relate to an apparatus and a method for controlling a multi-module fuel cell system and, more particularly, to an apparatus and a method for individually controlling fuel cell modules of a multi-module cell system.

### Description of the Related Art

In general, a fuel cell vehicle comprises a fuel cell stack, in which a plurality of fuel cells used as a power source are stacked, a fuel supply system that supplies hydrogen that is a fuel to the fuel cell stack, an air supply system that supplies oxygen that is an oxidizer that is necessary for an electrochemical reaction, a water/heat management system that controls a temperature of the fuel cell stack, and the like.

A fuel cell power generation system may comprise a plurality of fuel cell modules. When outputs required by the fuel cell stacks of the fuel cell system are equally determined to be a value obtained by dividing a required total output by the number of stacks, an output of the fuel cell system may be degraded when some of the fuel cell stacks break down. Furthermore, when the fuel cell stacks are operated at a high potential or a low potential, durability degrees of the stacks may be badly influenced. Accordingly, it is necessary to develop technologies for solving the problems.

### SUMMARY

The present disclosure has been made to solve the above-mentioned problems occurring in the existing technologies while advantages achieved by the existing technologies art are maintained intact.

An aspect of the present disclosure provides an apparatus and a method for individually controlling fuel cell module of a multi-module fuel cell system.

Another aspect of the present disclosure provides an apparatus for controlling a fuel cell system, by which durability degrees of fuel cell stacks may be secured by controlling voltage for cells of the fuel cell stacks in a proper range, a system including the same, and a method thereof.

Another aspect of the present disclosure provides an apparatus for equally controlling end of life (EOL) reaching time points of fuel cell modules of a multi-module fuel cell system, and a method thereof.

Another aspect of the present disclosure provides an apparatus for controlling a fuel cell system, by which an output of the fuel cell system is prevented from being degraded when some of fuel cell stacks irreversibly break down, a system including the same, and a method thereof.

Another aspect of the present disclosure provides an apparatus for controlling a fuel cell system, by which a sum of output amounts of individual stacks is prevented from becoming larger when minimum outputs thereof are controlled due to characteristics of a multi-module fuel cell system, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling a multi-module fuel cell system, the apparatus comprises a driving number calculator connected to one or more fuel cell stacks and that calculates a first number, based on a required total output and a preset fuel cell stack reference output in real time, a fuel cell stack driving determiner that determines driven ones of the one or more fuel cell stacks, based on priorities of the one or more fuel cell stacks and the first number, and a fuel cell stack output controller that controls an output of the driven fuel cell stack based on the required total output.

In an exemplary embodiment, the preset fuel cell stack reference output may be set based on an output range, in which continuous driving time periods of the one or more fuel cell stacks are not limited.

In an exemplary embodiment, the driving number calculator may be configured to calculate the first number based on a value obtained by dividing the required total output by the preset fuel cell stack reference output.

In an exemplary embodiment, the fuel cell stack driving determiner may be configured to monitor states of the one or more fuel cell stacks, and determine the priorities of the one or more fuel cell stacks based on the monitored states of the one or more fuel cell stacks.

In an exemplary embodiment, the states of the one or more fuel cell stacks may comprise one or more of accumulated output amounts or accumulated driving time periods of the one or more fuel cell stacks.

In an exemplary embodiment, the fuel cell stack driving determiner may be configured to determine the priorities of the one or more fuel cell stacks, based on a result obtained by multiplying the accumulated output amounts of the one or more fuel cell stacks and the accumulated driving time periods with weight values thereof, respectively, and adding multiplications thereof.

In an exemplary embodiment, the fuel cell stack driving determiner may be configured to determine whether the first number calculated in real time is larger than a second number that is the number of the currently driven fuel cell stacks, and determine a fuel cell stack that is to be additionally driven, based on the priorities of the one or more fuel cell stacks and the first number calculated in real time, when the first number is larger than the second number by a specific number or more, and the fuel cell stack output controller may be configured to control an output of the fuel cell stack that is to be additionally driven, based on the required total output.

In an exemplary embodiment, the fuel cell stack output controller may be configured to control an output of the currently driven fuel cell stack such that the currently driven fuel cell stacks generate the required total output until a startup of the fuel cell stack that is to be additionally driven is finished.

In an exemplary embodiment, the fuel cell stack output controller may be configured to determine whether the first number calculated in real time is larger than a second number that is the number of the currently driven fuel cell stacks by a specific number or more, and control an output of the currently driven fuel cell stacks such that the currently driven fuel cell stacks generates the required total output when the first number is not larger than the second number by the specific number or more.

In an exemplary embodiment, the fuel cell stack driving determiner may be configured to determine whether the required total output is lower than a sum of minimum outputs of the currently driven fuel cell stacks, and determine one of the currently driven fuel cell stacks, which is to be stopped, based on the priorities when the required total output is lower than the sum of the minimum outputs of the currently driven fuel cell stacks.

In an exemplary embodiment, the fuel cell stack output controller may be configured to determine outputs of the driven fuel cell stacks, based on a value obtained by dividing the required total output by a second number that is the number of the driven fuel cell stacks, and control an output of a fuel cell stack that is to be additionally driven, based on the determined output.

In an exemplary embodiment, the fuel cell stack output controller may be configured to control the outputs of the driven fuel cell stacks such that individual voltages of fuel cells that constitute the driven fuel cell stacks are included in a preset specific range, in which an upper limit and a lower limit are determined.

In an exemplary embodiment, the range, in which the upper limit and the lower limit are determined, may be set in consideration of degradation degrees or durability degrees of the one or more fuel cell stacks.

According to another aspect of the present disclosure, a method for controlling a multi-module fuel cell system may comprise calculating a first number, based on a required total output and a preset fuel cell stack reference output in real time, by a driving number calculator connected to one or more fuel cell stacks, determining driven ones of the one or more fuel cell stacks, based on priorities of the one or more fuel cell stacks and the first number, by a fuel cell stack driving determiner, and controlling outputs of the driven fuel cell stacks based on the required total output, by a fuel cell stack output controller.

In an exemplary embodiment, the calculating of the first number by the driving number calculator may comprise calculating the first number based on a value obtained by dividing the required total output by the preset fuel cell stack reference output, by the driving number calculator.

In an exemplary embodiment, the determining of the driven ones of the one or more fuel cell stacks, may comprise monitoring one or more of accumulated output amounts or accumulated driving time periods of the one or more fuel cell stacks, by the fuel cell stack driving determiner, and determining priorities of the one or more fuel cell stacks based on the monitored one or more of the accumulated output amounts or the accumulated driving time periods of the one or more fuel cell stacks, by the fuel cell stack driving determiner.

In an exemplary embodiment, the determining of the currently driven ones of the one or more fuel cell stacks, by the fuel cell stack driving determiner, may comprise determining whether the calculated first number is larger than a second number that is the number of the currently driven fuel cell stacks by a specific number or more in real time, by the fuel cell stack driving determiner, and determining a fuel cell stack that is to be additionally driven, based on the priorities of the one or more fuel cell stacks and the first number calculated in real time when the first number is larger than the second number by the specific number or more, by the fuel cell stack driving determiner, and the method may further comprise controlling an output of the fuel cell stack that is to be additionally driven, based on the required total output, by the fuel cell stack output controller.

In an exemplary embodiment, the method may further comprise determining whether the required total output is lower than a sum of minimum outputs of currently driven fuel cell stacks, by the fuel cell stack driving determiner, and determining one of the currently driven fuel cell stacks, which is to be stopped, based on the priorities when the required total output is lower than the sum of the minimum outputs of the currently driven fuel cell stacks, by the fuel cell stack driving determiner.

In an exemplary embodiment, the controlling of the outputs of the driven fuel cell stacks, by the fuel cell stack output controller, may comprise determining the outputs of the driven fuel cell stacks, based on a value obtained by dividing the required total output by a second number that is the number of the currently driven fuel cell stack, by the fuel cell stack output controller, and controlling outputs of the currently driven fuel cell stacks based on the determined outputs, by the fuel cell stack output controller.

In an exemplary embodiment, the controlling of the outputs of the driven fuel cell stacks, by the fuel cell stack output controller, may comprise controlling the outputs of the fuel cell stacks such that individual voltages of fuel cells that constitute the driven fuel cell stacks are included in a preset specific range, in which an upper limit and a lower limit are determined, by the fuel cell stack output controller.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for controlling the multi-module fuel cell system according to an exemplary embodiment of the present disclosure;

FIG. 2 is a view illustrating a detailed configuration of a multi-module fuel cell system according to an exemplary embodiment of the present disclosure;

FIG. 3 is a graph illustrating a result of comparison of degradation degrees according to lower limit voltages of a fuel cell stack;

FIG. 4 is a flowchart illustrating operations of an apparatus for controlling the multi-module fuel cell system according to an exemplary embodiment of the present disclosure;

FIG. 5 is a flowchart illustrating an operation of determining priorities of fuel cell modules, by an apparatus for controlling the multi-module fuel cell system according to an exemplary embodiment of the present disclosure;

FIG. 6 is a flowchart illustrating an operation of additionally driving or stopping a fuel cell module, by an apparatus for controlling the multi-module fuel cell system according to an exemplary embodiment of the present disclosure;

FIG. 7 is a flowchart illustrating a method for controlling a multi-module fuel cell system according to an exemplary embodiment of the present disclosure; and

FIG. 8 illustrates a computing system according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known, configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

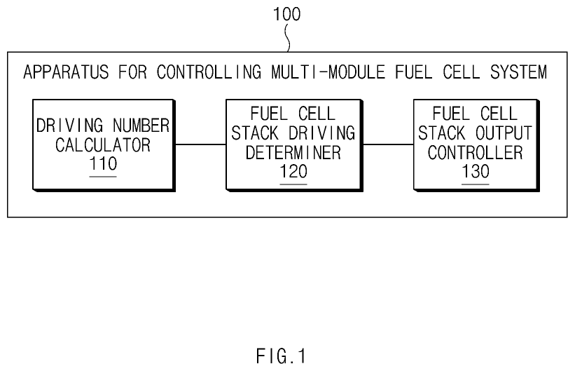

Hereinafter, embodiments of the present disclosure will be described in detail with reference to FIGS. 1 to 8.

FIG. 1 is a block diagram illustrating an apparatus for controlling the multi-module fuel cell system according to an exemplary embodiment of the present disclosure.

An apparatus 100 for controlling a multi-module fuel cell system according to the present disclosure may be implemented on an inside or an outside of the multi-module fuel cell system. Then, the apparatus 100 for controlling the multi-module fuel cell system may be integrally formed with internal control units of the multi-module fuel cell system, and may be implemented as a separate hardware device to be connected to the control units of the multi-module fuel cell system by a connection unit.

As an example, the apparatus 100 for controlling the multi-module fuel cell system may be integrally implemented with the multi-module fuel cell system, may be implemented to be installed in/attached to the multi-module fuel cell system as a separate configuration from the multi-module fuel cell system, or a portion thereof may be integrally implemented with the multi-module fuel cell system and another portion thereof may be implemented to be installed in/attached to the multi-module fuel cell system as a separate configuration from the multi-module fuel cell system.

As an example, the multi-module fuel cell system may be provided in a vehicle, and may be configured to supply electric power to motors, nodes, and/or other accessories of the vehicle.

The multi-module fuel cell system mean a fuel cell system, in which a plurality of fuel cell modules (or power module complete (PMC)) are connected in parallel to each other to generate a high output.

Referring to FIG. 1, the apparatus 100 for controlling the multi-module fuel cell system may comprise a driving number calculator 110, a fuel cell stack driving determiner 120, and a fuel cell stack output controller 130.

The driving number calculator 110, the fuel cell stack driving determiner 120, and the fuel cell stack output controller 130 may comprise a processor that performs data processing and/or calculations, which will be described below. Furthermore, the driving number calculator 110, the fuel cell stack driving determiner 120, and the fuel cell stack output controller 130 may comprise a memory, in which data or algorithms that are necessary for a process of performing data processing and/or calculations are stored.

The processor that may be included in the driving number calculator 110, the fuel cell stack driving determiner 120, and the fuel cell stack output controller 130 may be an electric circuit that executes commands of software. For example, the processor included in the driving number calculator 110, the fuel cell stack driving determiner 120, and the fuel cell stack output controller 130 may be a fuel-cell control unit (FCU), an electronic control unit (ECU), a micro controller unit (MCU), or another low level controller.

The memory that may be included in the driving number calculator 110, the fuel cell stack driving determiner 120, and the fuel cell stack output controller 130 may comprise a memory, such as a flash memory type, a hard disk type, a micro type, or a card type (for example, a secure digital (SD) card or an eXtream digital (XD) card), and a storage medium of at least one of memories, such as a random access memory (RAM), a static RAM (SRM), a read-only memory (ROM), a programmable ROM (PROM), an electrically erasable PROM (EEPROM), a magnetic RAM (MRAM), a magnetic disk, and an optical disk.

The driving number calculator 110 may be connected to one or more fuel cell stacks and may be configured to calculate a first number, based on, a total output required in real time and a preset fuel cell stack reference output.

Here, the one or more fuel cell stacks may refer to fuel cell stacks included in the one or more fuel cell modules (or power module complete (PMC)) that are connected in parallel to each other.

Here, a first number may refer to a target driving number of fuel cell stacks that are calculated to cause the individual fuel cell stacks to generate an output of an appropriate level and to generate a total output required for the entire fuel cell system.

Here, the preset fuel cell stack reference output may be set based on an output range, in which continuous driving time periods of the one or more fuel cell stacks are not limited.

The output range, in which the continuous driving time periods are not limited, may refer to a low-output area according to a fuel cell normal production reference, and may be determined by an output range of not less than 44 kW and less than 68 kW.

As another example, the fuel cell stack reference output may be determined based on an output range, in which the voltages of the cells of the fuel cells are maintained at 0.7 V to 0.8 V (a constant output range of about 40 kW to 60 kW).

Exemplarily, the fuel cell stack reference output may be determined by an intermediate value of the corresponding output range or the like.

As an example, the fuel cell stack reference output may be determined to be 50 kW.

As an example, the driving number calculator 110 may be configured to acquire information on the required total output by receiving information on the total output required for an upper level controller.

As an example, the driving number calculator 110 may be configured to calculate the first number based on a value obtained by dividing the required total output by the preset fuel cell stack reference output.

As an example, the driving number calculator 110 may be configured to calculate the first number by an integer value that is rounded off to the nearest integer or is raised to a unit when the value obtained by dividing the required total output by the preset fuel cell stack reference output is not an integer.

As an example, the driving number calculator 110 may be configured to deliver information on the calculated first number to the fuel cell stack driving determiner 120.

The fuel cell stack driving determiner 120 may be configured to determine a driven one of the one or more fuel cell stacks, based on priorities of the one or more fuel cells and the first number.

As an example, the fuel cell stack driving determiner 120 may be configured to determine the first number of fuel cell stacks as the fuel cell stacks that are to be driven, in order of priority.

As an example, the fuel cell stack driving determiner 120 may be configured to individually monitor states of accumulated output amounts, accumulated driving time periods, and the like of the one or more fuel cell stacks, and may be configured to determine priorities of the one or more fuel cell stacks based on the monitored states of the one or more fuel cell stacks.

As an example, the fuel cell stack driving determiner 120 may comprise a non-volatile memory (WM) that stores information on one or more of the accumulated output amounts or the accumulated driving time periods of the individual fuel cell stacks.

As an example, the fuel cell stack driving determiner 120 may be configured to update information on one or more of the accumulated output amounts or the accumulated driving time periods of the individual fuel cell stacks, which are stored in the non-volatile memory when driving of the fuel cell stacks is finished.

In this process, the fuel cell stack driving determiner 120 may be configured to update the information on the accumulated output amounts or the accumulated driving time periods of the individual fuel stacks, which are stored in the non-volatile memory by adding output amounts or driving time periods of the individual fuel cell stacks in recent driving to the accumulated output amounts or the accumulated driving time periods of the individual fuel cell stacks, which have been accumulated until the previous driving time period, when the driving of the fuel cell stacks is finished.

As an example, the fuel cell stack driving determiner 120 may be configured to determine one or more of the accumulated output amounts or the accumulated driving time periods of the individual fuel cell stacks in real time, through one or more of information on one or more of the accumulated output amounts or the accumulated driving time periods of the individual fuel cell stacks, which have been accumulated until the previous driving process and are stored in the non-volatile memory, and output amounts or driving time periods that are measured in real time.

As an example, the fuel cell stack driving determiner 120 may be configured to determine the priorities of the one or more fuel cell stacks, based on a result obtained by multiplying the accumulated output amounts and the driving time periods of the one or more fuel cell stacks with their weights.

In a detailed example, the fuel cell stack driving determiner 120 may be configured to determine the priorities of the one or more fuel cell stacks, according to a result obtained by multiplying the accumulated driving time periods with a weight value of 0.6 and multiplying the accumulated output amounts with a weight value of 0.4, respectively, and adding multiplications thereof.

Here, the accumulated output amounts and the accumulated driving time periods are exemplified as parameters that represent the states of the individual fuel cell stacks, but other parameters may be used according to an exemplary embodiment.

As an example, the fuel cell stack driving determiner 120 may be configured to determine whether the first number calculated in real time is larger than a second number that is the number of currently driven fuel cell stacks by a specific number, and may be configured to determine a fuel cell stack that is to be additionally driven, based on the priorities of the one or more fuel cell stacks and the first number calculated in real time when the first number is greater than the second number by the specific number.

As an example, the fuel cell stack driving determiner 120 may be configured to identify the number of the currently driven fuel cell stacks in real time.

When the first number calculated in real time is larger than the number of the currently driven fuel cell stack but is not larger by the specific number or more, a required total output may be generated through the currently driven fuel cell stacks.

The fuel cell stack driving determiner 120 may be configured to determine whether the first number calculated in real time is larger than the number of the currently driven fuel cell stacks by the specific number or more, and thus may be configured to prevent excessively frequent startups or stops of the fuel cells and may be configured to maintain the outputs of the individual fuel cell stacks of a reference output level.

As an example, the fuel cell stack driving determiner 120 may be configured to determine whether the required total output is lower than a sum of minimum outputs of the currently driven fuel cell stacks, and may be configured to determine one of the currently driven fuel cell stacks, which is to be stopped, based on the priorities when the required total output is lower than the sum of the minimum outputs of the currently driven fuel cell stacks.

Even when the first number calculated in real time is smaller than the number of the currently driven fuel cell stacks, the fuel cells that do not need to lower the individual outputs of the fuel cell stacks that are driven may be prevented from being stopped, while the driven fuel cell stacks are not stopped.

When the required total output is lower than the sum of the minimum outputs of the currently driven fuel cell stacks, an output that is higher than the required total output may be generated, and thus the currently driven fuel cell stacks need to be stopped.

The fuel cell stack output controller 130 may be configured to control outputs of driven fuel cell stacks, based on the required total output.

As an example, the fuel cell stack output controller 130 may be configured to calculate the outputs of the fuel cell stacks by dividing the required total output by the number of the driven fuel cell stacks, and may be configured to control the outputs of the individual fuel cell stacks according to the calculated outputs.

As an example, in the case where the fuel cell stack is additionally driven, the fuel cell stack output controller 130 may be configured to calculate the outputs of the fuel cell stacks by dividing the required total output by the total number of the fuel cells, which also comprises the number of the fuel cell stacks added to the number of the fuel cell stacks that are driven previously, and may be configured to control the outputs of the individual fuel cell stacks according to the calculated outputs.

As an example, the fuel cell stack output controller 130 may be configured to control the outputs of the currently driven fuel cell stacks with a value obtained by dividing the required total output by the number of the fuel cell stacks driven previously so that the fuel cell stack driven previously generate the required total output until the startup of the additionally driven fuel cell stack is finished when the fuel cell stack is additionally driven.

As an example, the fuel cell stack output controller 130 may be configured to determine whether the first number calculated in real time is larger than the second number that is the number of the currently driven fuel cell stacks by the specific number or more, and may be configured to control the outputs of the currently driven fuel cell stacks so that the currently driven fuel cell stacks generate the required total output when the first number is not larger than the second number by the specific number or more.

Whether the first number calculated in real time is larger than the second number that is the number of the currently driven fuel cell stacks by the specific number or more may be determined by the fuel cell stack driving determiner 120 and the fuel cell stack output controller 130.

As an example, the fuel cell stack output controller 130 may be configured to control the outputs of the driven fuel cell stacks such that individual voltages of the fuel cells that constitute the driven fuel cell stacks are included in a preset specific range, in which an upper limit and a lower limit are determined.

Here, the specific range, in which the upper limit and the lower limit are determined, may be set in consideration of degradation degrees or durability degrees of the one or more fuel cell stacks.

When the individual voltages of the fuel cells are maintained at 0.7 V to 0.8 V, the degradation degrees or the durability degrees of the fuel cell stacks may be enhanced.

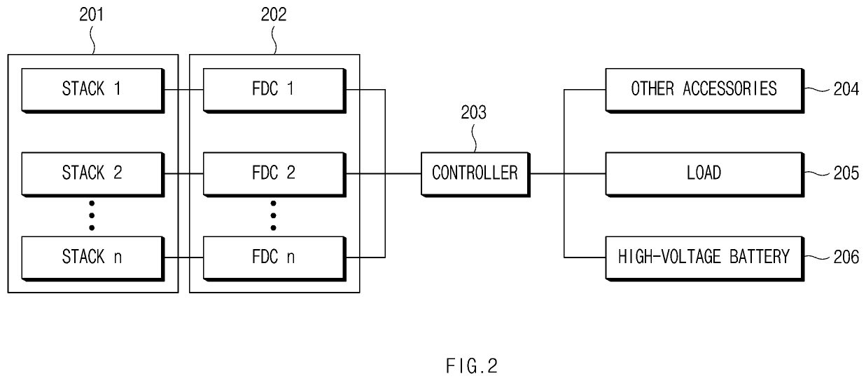

FIG. 2 is a view illustrating, a detailed configuration of a multi-module fuel cell system according to an exemplary embodiment of the present disclosure.

Referring to FIG. 2, the multi-module fuel cell system may comprise one or more fuel cell stacks 201, one or more fuel-cell DC-DC converters (FDCs) 202, and a controller 203.

Furthermore, as an example, the multi-module fuel cell system may be connected to other accessories 204, a load 205, and a high-voltage battery 206 of the vehicle.

The one or more fuel cell stacks 201 may be configured to generate electric power that is to be supplied to the other accessories 204 and the load 205.

The fuel cell stacks 201 may be connected to the corresponding FDCs 202.

The FDCs 202 may be configured to raise or reduce the voltage of the electric power generated by the fuel cell stacks 201.

The FDCs 202 may be configured to deliver the elects is power, the voltage of which is raised, to the load 205 or the other accessories 204, or may be configured to charge the high-voltage battery 206.

Furthermore, the FDCs 202 may be configured to control power productions of the individual fuel cell stacks 201 by controlling currents and voltages of the fuel cell stacks 201.

The controller 203 is one controller connected to the one or more FDCs 202, and may comprise one or more processors that perform data processing and commands.

The controller 203 may comprise an FCU.

The controller 203 may be configured to monitor or diagnose states, such as whether the one or more fuel cell stacks 201 may be driven, outputs and driving time periods of the one or more fuel cell stacks 201, through the one or more FDCs 202.

Furthermore, the controller 203 may be configured to control the outputs of the one or more fuel cell stacks 201 according to the monitored or diagnosed states of the one or more fuel cell stacks 201.

The controller 203 may be configured to control all the power productions produced through the one or more fuel cell stacks 201.

The controller 203 may be configured to control distribution of the produced electric power.

The output required by the multi-module fuel cell system may comprise an output required by the load 205 and other accessories 204.

The other accessories 204 may comprise an air compressor, a humidifier, a cathode oxygen depletion (COD) heater, and a cooling water pump of the fuel cell system and the vehicle.

The electric power produced through the fuel cell stacks 201 and the high-voltage battery 206 has to be supplied to the load 205 and the other accessories 204.

Accordingly, the electric power produced through the fuel cell stacks 201 and the high-voltage battery 206 may be not lower than the electric power required by the load 205 and the other accessories 204, and to achieve this, the controller 203 may be configured to control production and distribution of the electric power.

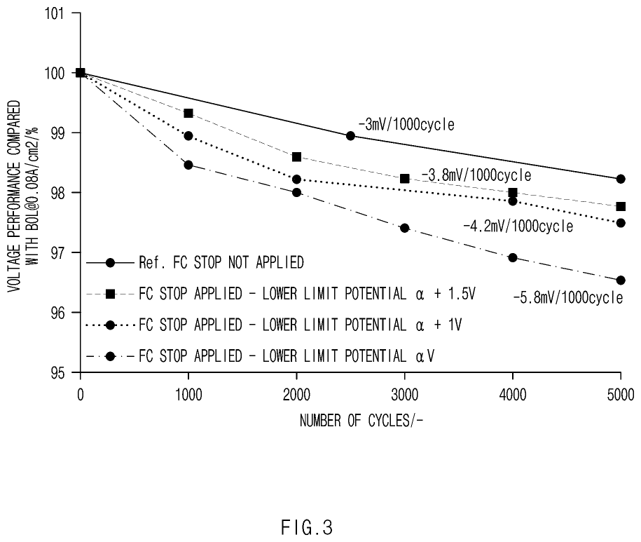

FIG. 3 is a graph illustrating a result of comparison of degradation degrees according to lower limit voltages of a fuel cell stack.

In particular, FIG. 3 is a graph illustrating a result of an experiment for comparing degradation degrees according to lower limit voltages of the fuel cells when a fuel cell (FC) stop is applied.

Referring to the graph, when the FC stop is not applied, a voltage performance of 3 mV per 1000 cycles was decreased.

When the FC stop is applied, a voltage performance of 3.8 mV per 1000 cycles was decreased when the lower limit voltage of the fuel cells is α+1.5 V. Here, α is an engineering value that may be set differently if necessary, and the corresponding α is not limited to a specific value in relation to the present disclosure.

When the FC stop is applied, a voltage performance of 4.2 mV per 1000 cycles was decreased when the lower limit voltage of the fuel cells is α+1 V.

When the FC stop is applied, a voltage performance of 5.8 mV per 1000 cycles was decreased when the lower limit voltage of the fuel cells is α V.

The degradation speeds of the fuel, cells may be accelerated in a sequence of the case of α+1.5 V, the case of α+1 V, and the case of α V.

Accordingly, in consideration of the degradation degrees or the durability degrees of the fuel cells, it is necessary to set an operation area in consideration of the lower limit voltage when the FC stop is applied.

During a normal operation of the fuel cell stacks as well as during the FC stop, it is necessary to maintain the lower limit voltage of the fuel cells.

Furthermore, the fuel cell stacks may badly influence a high-potential durability as well as a low-potential durability.

It is preferable that the voltages for the fuel cells are controlled in consideration of an aspect of the durability degrees or the degradation degrees of the fuel cell stacks.

Accordingly, to improve the durability degrees of the fuel cell stacks, it may be efficient to minimize operation in high-output areas (for example, area of outputs of 80 kW or more), and control the outputs of the fuel cell stacks in areas (for example, areas of outputs of about 40 kW to 50 kW) of a relatively low output.

The numerical numbers are exemplary, and numerical numbers that are experimentally determined or calculated may be used.

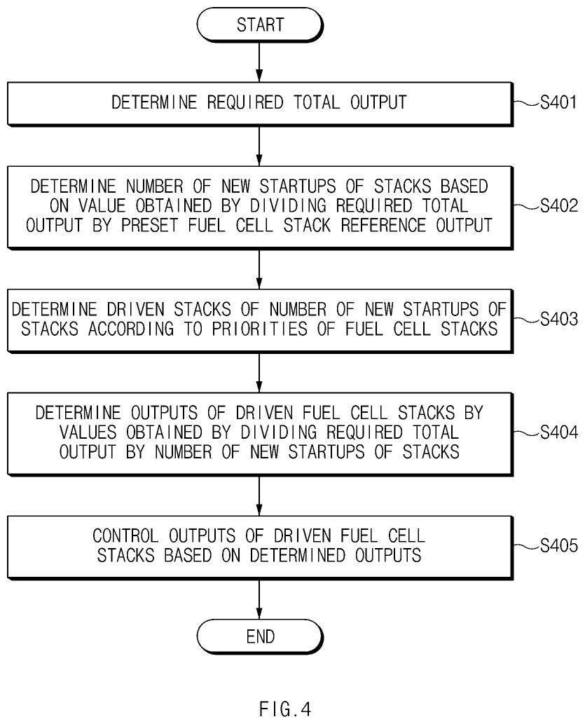

FIG. 4 is a flowchart illustrating operations of the apparatus for controlling the multi-module fuel cell system according to an exemplary embodiment of the present disclosure.

Referring to FIG. 4, the apparatus for controlling the multi-module fuel cell system may be configured to determine the required total output (S401).

As an example, the apparatus for controlling the multi-module fuel cell system may be configured to receive information on the total output required for the multi-module fuel cell system from the upper level controller.

The apparatus for controlling the multi-module fuel cell system may be configured to determine the number of new startups of the stacks based on a value obtained by dividing the required total output by a preset fuel cell stack reference output (S402).

As an example, the apparatus for controlling the multi-module fuel cell system may be configured to determine an integer value, which is rounded off to the nearest integer or is raised to a unit, of a value obtained by dividing the required total output by the preset fuel cell stack reference value as the number of the new startups of the stacks when fuel cell stacks are newly started up in a situation, in which all the fuel cell stacks are stopped.

The apparatus for controlling the multi-module fuel cell system may be configured to determine driving stacks of the number of the new startups of the stacks according to the priorities of the fuel cell stacks (S403).

As an example, the apparatus for controlling the multi-module fuel cell system may be configured to determine the fuel cell stacks the number of the new startups of the stacks according to the priorities calculated based on the accumulated output amounts or the accumulated driving time periods of the individual fuel cell stacks.

The apparatus for controlling the multi-module fuel cell system may be configured to determine the outputs of the driven fuel cell stacks by a value obtained by dividing the required total output by the number of the new startups of the stacks (S404).

The apparatus for controlling the multi-module fuel cell system may be configured to control the outputs of the driven fuel cell stacks based on the determined outputs (S405).

As an example, the apparatus for controlling the multi-module fuel cell system may be configured to control the outputs of the fuel cell stacks such that the fuel cell stacks of the number of the determined new startups of the stacks generate the determined outputs.

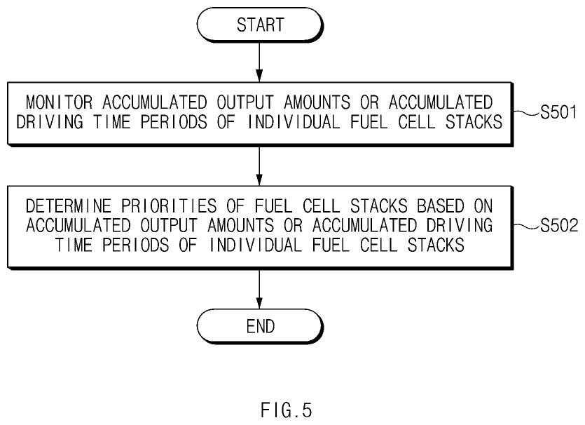

FIG. 5 is a flowchart illustrating an operation of determining priorities of the fuel cell modules, by the apparatus for controlling the multi-module fuel cell system according to an exemplary embodiment of the present disclosure.

Referring to FIG. 5, the apparatus for controlling the multi-module fuel cell system may be configured to monitor the accumulated output amounts or the accumulated driving time periods of the individual fuel cell stacks (S501).

As an example, the apparatus for controlling the multi-module fuel cell system may be configured to store information on the accumulated output amounts or the accumulated driving time periods of the individual fuel cell stacks in a non-volatile memory (NVM).

As an example, the apparatus for controlling the multi-module fuel cell system may be configured to add output amounts generated during the driving of the individual fuel cell stacks or consumed driving time periods to the accumulated output amounts or the accumulated driving time periods stored in the non-volatile memory (NVM) and may be configured to store the result.

The apparatus for controlling the multi-module fuel cell system may be configured to determine the priorities of the fuel cell stacks based on the accumulated output amounts or the accumulated driving time periods of the individual fuel cell stacks (S502).

As an example, the apparatus for controlling the multi-module fuel cell system may be configured to give higher priorities to the fuel cell stacks as the accumulated output amounts are lower and the accumulated driving time periods are shorter.

As an example, the apparatus for controlling the multi-module fuel cell system may be configured to determine the priorities of the fuel cell stacks based on values obtained by multiplying the accumulated output amounts and the accumulated driving time periods with preset weight values thereof.

As an example, the apparatus for controlling the multi-module fuel cell system may be configured to give higher priorities as the sum of the values obtained by multiplying the accumulated output amounts and the accumulated driving time periods with the preset weight values are lower.

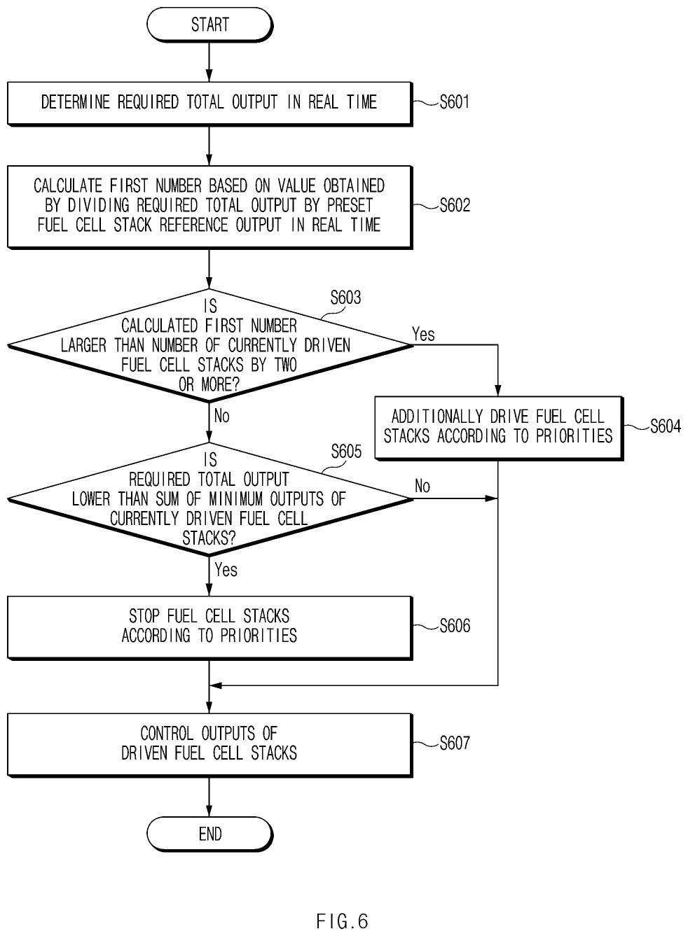

FIG. 6 is a flowchart illustrating an operation of additionally driving or stopping a fuel cell module, by the apparatus for controlling the multi-module fuel cell system according to an exemplary embodiment of the present disclosure.

Referring to FIG. 6, the apparatus for controlling the multi-module fuel cell system may be configured to determine the required total output in real time (S601).

As an example, the apparatus for controlling the multi-module fuel cell system may be configured to receive information on the total output required for the multi-module fuel cell system from the upper level controller.

The apparatus for controlling the multi-module fuel cell system may be configured to calculate the first number based on a value obtained by dividing the required total output by the preset fuel cell stack reference output in real time (S602).

As an example, the apparatus for controlling the multi-module fuel cell system may be configured to determine the first number by an integer value rounded off to the nearest integer or raised to a unit, which is obtained by dividing the required total output by the preset fuel cell stack reference output.

The apparatus for controlling the multi-module fuel cell system may be configured to identify whether the calculated first number is larger than the number of the currently driven fuel cell stacks by two or more (S603).

Here, the specific number of two is a value that is determined for exemplification, and may be determined to be another specific number for additional driving of the fuel cell stacks in actual cases.

The apparatus for controlling the multi-module fuel cell system may be configured to additionally drive the fuel cell stacks according to the priorities when the calculated first number is larger than the number of the currently driven fuel cell stacks by two or more.

As an example, the apparatus for controlling the multi-module fuel cell system may be configured to additionally newly drive fuel cell stacks of a number obtained by subtracting the number of the currently driven fuel cell stacks from the first number in a sequence of the higher priorities of the fuel cell stacks, which are not driven.

The apparatus for controlling the multi-module fuel cell system may be configured to identify whether the required total output is lower than a sum of the minimum outputs of the currently driven fuel cell stacks when the calculated first number is not larger than the number of the currently driven fuel cell stacks by two or more (S605).

Here, the minimum outputs of the fuel cell stacks may refer to minimum electric power that may be output in a state, in which the fuel cell stacks are started but are not finished.

The apparatus for controlling the multi-module fuel cell system may be configured to stop the fuel cell stacks according to the priorities when the required total output is lower than the sum of the minimum outputs of the currently driven fuel cell stacks (S606).

As an example, the apparatus for controlling the multi-module fuel cell system may be configured to stop one or more fuel cell stacks in a sequence of lower priorities such that the required total output is not less than the sum of the minimum outputs of the fuel cell stacks when the required total output is lower than the sum of the minimum outputs of the currently driven fuel cell stacks.

The apparatus for controlling the multi-module fuel cell system may be configured to control the outputs of the driven fuel cell when the required total output is not lower than the sum of the minimum outputs of the currently driven fuel cell stacks (S607).

As an example, the apparatus for controlling the multi-module fuel cell system may be configured to control the outputs of the driven fuel cell stacks by a value obtained by dividing the total output by the number of the fuel cell stacks.

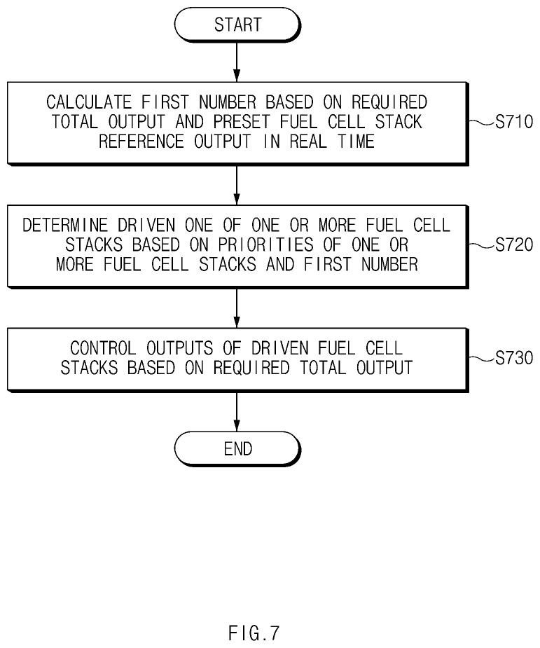

FIG. 7 is a flowchart illustrating a method for controlling the multi-module fuel cell system according to an exemplary embodiment of the present disclosure.

Referring to FIG. 7, the method for controlling the multi-module fuel cell system may comprise an operation (S710) of calculating a first number, based on a required total output and a preset fuel cell stack reference output in real time, an operation (S720) of determining driven ones of the one or more fuel cell stacks, based on priorities of the one or more fuel cells and the first number, and an operation (S730) of controlling outputs of the currently driven fuel cell stacks based on the required total output.

The operation (S710) of calculating the first number based on the required total output and the preset fuel cell stack reference output in real time may be performed by the driving number calculator.

As an example, the operation (S710) of calculating the first number may comprise an operation of calculating the first number based on a value obtained by dividing the required total output by the preset fuel cell stack reference output.

The operation (S720) of determining the driven ones of the one or more fuel cell stacks, based on the priorities of the one or more fuel cells and the first number may be performed by the fuel cell stack driving determiner.

As an example, the operation of determining the driven ones of the one or more fuel cell stacks may comprise an operation of monitoring one or more of accumulated output amounts or accumulated driving time periods of the one or more fuel cell stacks, by the fuel cell stack driving determiner, and an operation of determining priorities of the one or more fuel cell stacks based on the monitored one or more of the accumulated output amounts or the accumulated driving time periods of the one or more fuel cell stacks, by the fuel cell stack driving determiner.

As an example, the operation (S720) of determining the currently driven ones of the one or more fuel cell stacks may comprise an operation of determining whether the calculated first number is larger than a second number that is the number of the currently driven fuel cell stacks by a specific number or more in real time, by the fuel cell stack driving determiner; and an operation of determining a fuel cell stack that are to be additionally driven, based on the priorities of the one or more fuel cell stacks and the first number calculated in real time when the first number is larger than the second number by the specific number or more, by the fuel cell stack driving determiner.

As an example, the method for controlling the multi-module fuel cell system may further comprise an operation of controlling an output of the fuel cell stack that is to be additionally driven, based on the required total output, by a fuel cell stack output controller.

As an example, the method for controlling the multi-module fuel cell system may further comprise an operation of determining whether the required total output is lower than a sum of minimum outputs of currently driven fuel cell stacks, by the fuel cell stack driving determiner, and an operation of determining one of the currently driven fuel cell stacks, which is to be stopped, based on the priorities when the required total output is lower than the sum of the minimum outputs of the currently driven fuel cell stacks, by the fuel cell stack driving determiner.

The operation (S730) of controlling the outputs of the driven fuel cell stacks based on the required total output may be performed by the fuel cell stack output controller.

As an example, the operation (S730) of controlling the outputs of the driven fuel cell stacks may comprise an operation of determining the outputs of the driven fuel cell stacks, based on a value obtained by dividing the required total output by a second number that is the number of the currently driven fuel cell stack, by the fuel cell stack output controller, and an operation of controlling outputs of the currently driven fuel cell stacks based on the determined outputs, by the fuel cell stack output controller.

As an example, the operation (S730) of controlling the outputs of the driven fuel cell stacks may comprise an operation of controlling the outputs of the fuel cell stacks such that individual voltages of fuel cells that constitute the driven fuel cell stacks are included in a preset specific range, in which an upper limit and a lower limit are determined, by the fuel cell stack output controller.

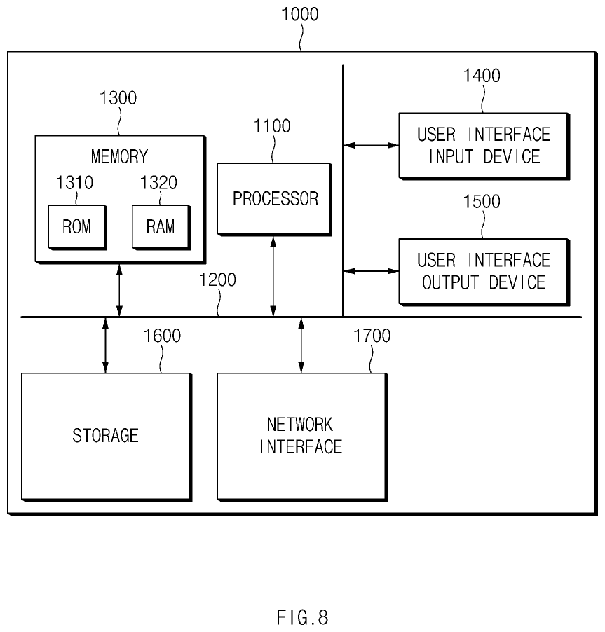

FIG. 8 illustrates a computing system according to an exemplary embodiment of the present disclosure.

Referring to FIG. 8, the computing system 1000 may comprise at least one processor 1100, a memory 1300, a user interface input device 1400, a user interface output device 1500, storage 1600, and a network interface 1700, which are connected through a bus 1200.

The processor 1100 may be a central processing unit (CPU) or a semiconductor device that processes instructions stored in the memory 1300 and/or the storage 1600. The memory 1300 and the storage 1600 may comprise various volatile or nonvolatile storage media. For example, the memory 1300 may comprise a read only memory (ROM) and a random access memory (RAM).

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM.

The exemplary storage medium may be coupled to the processor 1100, and the processor 1100 may be configured to read information from the storage medium and may be configured to write information in the storage medium. In another method, the storage medium may be integrated with the processor 1100. The processor and the storage medium may be configured to reside in an application specific integrated circuit (ASIC). The ASIC may be configured to reside in a user terminal. In another method, the processor and the storage medium may be configured to reside in the user terminal as an individual component.

Effects of the apparatus for controlling the multi-module fuel cell power generating system and the method thereof according to the present disclosure will be described as follows.

According to at least one of the embodiments of the present disclosure, an apparatus and a method for individually controlling fuel cell modules of a multi-module fuel cell system.

According to at least one of the embodiments of the present disclosure, an apparatus for controlling a fuel cell system, by which durability degrees of fuel cell stacks may be secured by controlling voltage for cells of the fuel cell stacks in a proper range, a system including the same, and a method thereof may be provided.

According to at least one of the embodiments of the present disclosure, an apparatus for equally controlling end of life (EOL) reaching time points of fuel cell modules of a multi-module fuel cell system, and a method thereof may be provided.

According to at least one of the embodiments of the present disclosure, an apparatus for controlling a fuel cell system, by which an output of the fuel cell system may be prevented from being degraded when some of fuel cell stacks irreversibly break down, a system including the same, and a method thereof may be provided.

Another aspect of the present disclosure provides an apparatus for controlling a fuel cell system, by which a sum of output amounts of individual stacks is prevented from becoming larger when minimum outputs thereof are controlled due to characteristics of a multi-module fuel cell system, a system including the same, and a method thereof may be provided.

In addition, the present disclosure may provide various effects that are directly or indirectly recognized.

The above description is a simple exemplification of the technical spirits of the present disclosure, and the present disclosure may be variously corrected and modified by those skilled in the art to which the present disclosure pertains without departing from the essential features of the present disclosure.

Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. An apparatus for controlling a multi-module fuel cell system, the apparatus comprising:
a driving number calculator connected to one or more fuel cell stacks and configured to calculate a first number, based on a required total output and a preset fuel cell stack reference output in real time;
a fuel cell stack driving determiner configured to determine driven ones of the one or more fuel cell stacks, based on priorities of the one or more fuel cell stacks and the first number; and
a fuel cell stack output controller configured to control an output of a driven fuel cell stack based on the required total output.

2. The apparatus of claim 1, wherein the preset fuel cell stack reference output is set based on an output range, in which continuous driving time periods of the one or more fuel cell stacks are not limited.

3. The apparatus of claim 1, wherein the driving number calculator is configured to calculate the first number based on a value obtained by dividing the required total output by the preset fuel cell stack reference output.

4. The apparatus of claim 1, wherein the fuel cell stack driving determiner is configured to:
monitor states of the one or more fuel cell stacks; and
determine the priorities of the one or more fuel cell stacks based on the monitored states of the one or more fuel cell stacks.

5. The apparatus of claim 4, wherein the states of the one or more fuel cell stacks comprise one or more of the following:
accumulated output amounts of the one or more fuel cell stacks; and
accumulated driving time periods of the one or more fuel cell stacks.

6. The apparatus of claim 5, wherein the fuel cell stack driving determiner is configured to determine the priorities of the one or more fuel cell stacks, based on a result obtained by:
multiplying the accumulated output amounts of the one or more fuel cell stacks and the accumulated driving time periods with weight values thereof, respectively; and
adding multiplications thereof.

7. The apparatus of claim 1, wherein the fuel cell stack driving determiner is configured to:
determine whether the first number calculated in real time is larger than a second number that is a number of currently driven fuel cell stacks; and
determine a fuel cell stack that is to be additionally driven, based on the priorities of the one or more fuel cell stacks and the first number calculated in real time, when the first number is larger than the second number by a specific number or more,
wherein the fuel cell stack output controller is configured to control an output of the fuel cell stack that is to be additionally driven, based on the required total output.

8. The apparatus of claim 7, wherein the fuel cell stack output controller is configured to control an output of the currently driven fuel cell stacks such that the currently driven fuel cell stacks generate the required total output until a startup of the fuel cell stack that is to be additionally driven is finished.

9. The apparatus of claim 1, wherein the fuel cell stack output controller is configured to:
determine whether the first number calculated in real time is larger than a second number that is a number of currently driven fuel cell stacks by a specific number or more; and
control an output of the currently driven fuel cell stacks such that the currently driven fuel cell stacks generate the required total output when the first number is not larger than the second number by the specific number or more.

10. The apparatus of claim 1, wherein the fuel cell stack driving determiner is configured to:
determine whether the required total output is lower than a sum of minimum outputs of currently driven fuel cell stacks; and
determine one of the currently driven fuel cell stacks, which is to be stopped, based on the priorities when the required total output is lower than the sum of the minimum outputs of the currently driven fuel cell stacks.

11. The apparatus of claim 1, wherein the fuel cell stack output controller is configured to:
determine outputs of driven fuel cell stacks, based on a value obtained by dividing the required total output by a second number that is a number of the driven fuel cell stacks; and
control an output of a fuel cell stack that is to be additionally driven, based on the determined output.

12. The apparatus of claim 1, wherein the fuel cell stack output controller is configured to control outputs of driven fuel cell stacks such that individual voltages of fuel cells that constitute the driven fuel cell stacks are included in a preset specific range, in which an upper limit and a lower limit are determined.

13. The apparatus of claim 12, wherein the preset specific range, in which the upper limit and the lower limit are determined, is set in consideration of degradation degrees or durability degrees of the one or more fuel cell stacks.

14. A method for controlling a multi-module fuel cell system, the method comprising:
calculating a first number, based on a required total output and a preset fuel cell stack reference output in real time, by a driving number calculator connected to one or more fuel cell stacks;
determining driven ones of the one or more fuel cell stacks, based on priorities of the one or more fuel cell stacks and the first number, by a fuel cell stack driving determiner; and
controlling outputs of driven fuel cell stacks based on the required total output, by a fuel cell stack output controller.

15. The method of claim 14, wherein the calculating of the first number by the driving number calculator comprises calculating the first number based on a value obtained by dividing the required total output by the preset fuel cell stack reference output, by the driving number calculator.

16. The method of claim 14, wherein the determining the driven ones of the one or more fuel cell stacks, by the fuel cell stack driving determiner, comprises:
monitoring one or more of accumulated output amounts or accumulated driving time periods of the one or more fuel cell stacks, by the fuel cell stack driving determiner; and
determining priorities of the one or more fuel cell stacks based on the monitored one or more of the accumulated output amounts or the accumulated driving time periods of the one or more fuel cell stacks, by the fuel cell stack driving determiner.

17. The method of claim 14, wherein the determining the driven ones of the one or more fuel cell stacks, by the fuel cell stack driving determiner, comprises:
determining whether the calculated first number is larger than a second number that is a number of currently driven fuel cell stacks by a specific number or more in real time, by the fuel cell stack driving determiner; and
determining a fuel cell stack that is to be additionally driven, based on the priorities of the one or more fuel cell stacks and the first number calculated in real time when the first number is larger than the second number by the specific number or more,
wherein the method further comprises controlling an output of the fuel cell stack that is to be additionally driven, based on the required total output, by the fuel cell stack output controller.

18. The method of claim 14, further comprising:
determining whether the required total output is lower than a sum of minimum outputs of currently driven fuel cell stacks, by the fuel cell stack driving determiner; and
determining one of the currently driven fuel cell stacks, which is to be stopped, based on the priorities when the required total output is lower than the sum of the minimum outputs of the currently driven fuel cell stacks, by the fuel cell stack driving determiner.

19. The method of claim 14, wherein the controlling of the outputs of the driven fuel cell stacks, by the fuel cell stack output controller, comprises:
determining the outputs of the driven fuel cell stacks, based on a value obtained by dividing the required total output by a second number that is the number of the currently driven fuel cell stack, by the fuel cell stack output controller; and
controlling outputs of the currently driven fuel cell stacks based on the determined outputs, by the fuel cell stack output controller.

20. The method of claim 14, wherein the controlling of the outputs of the driven fuel cell stacks, by the fuel cell stack output controller, comprises controlling the outputs of the fuel cell stacks such that individual voltages of fuel cells that constitute the driven fuel cell stacks are included in a preset specific range, in which an upper limit and a lower limit are determined, by the fuel cell stack output controller.
